(19) United States
(12) Patent Application Publication
(10) Pub. No.: US 2025/0048072 A1
(43) Pub. Date: Feb. 6, 2025

(54) INFORMATION TRANSMISSION METHODS, COMMUNICATION DEVICES, AND STORAGE MEDIA

(71) Applicant: Beijing Xiaomi Mobile Software Co., Ltd., Beijing (CN)

(72) Inventor: Jianning LIU, Beijing (CN)

(73) Assignee: Beijing Xiaomi Mobile Software Co., Ltd., Beijing (CN)

(21) Appl. No.: 18/847,940

(22) PCT Filed: Mar. 18, 2022
(86) PCT No.: PCT/CN2022/081793

§ 371 Date: Sep. 17, 2024

(51) Int. Cl. H04W 8/00; H04W 4/38; H04W 4/50

(52) U.S. Cl. CPC H04W 8/005; H04W 4/38; H04W 4/50

(57) ABSTRACT

A method, communication device and computer readable medium for information transmission in a wireless communication network. The information transmission is performed by receiving, by a base station, a first sensing service request from a user equipment (UE), where the first sensing service request is at least configured to request a network to provide a sensing service to the UE.

### CROSS-REFERENCE TO RELATED APPLICATIONS

The present application is a U.S. national phase of International Application No. PCT/CN2022/081793, filed on Mar. 18, 2022, the disclosure of which is incorporated herein by reference in its entirety for all purposes.

### TECHNICAL FIELD

The present disclosure relates to but is not limited to the field of wireless communication technologies, and in particular to information transmission methods and apparatuses, communication devices, and storage media.

### BACKGROUND

In cellular mobile communication technology, a mobile communication network can adopt an integrated communication and sensing scheme to integrate a communication function and a sensing function, so that the communication system has both the communication function and the sensing function. By actively recognizing and analyzing characteristics of a wireless channel while transmitting sensing information, physical characteristics of the surrounding environment can be sensed.

For example, a communication and sensing system implementing the integrated communication and sensing scheme can include: a transmitter for sending sensing information; a receiver for sending, upon receiving sensing information, sensing data to a processor, where the sensing information received by the receiver can be reflected by a sensed object; and the processor for processing the sensing data received from the receiver and outputting a sensing result. The processor can include one or more processors, or one or more processing apparatuses.

### SUMMARY

In view of this, the embodiments of the present disclosure provide information transmission methods and apparatuses, communication devices, and storage media.

According to a first aspect of the embodiments of the present disclosure, there is provided an information transmission method performed by a base station. The method includes: receiving a first sensing service request from a user equipment (UE), where the first sensing service request is at least configured to request a network to provide a sensing service to the UE.

According to a second aspect of the embodiments of the present disclosure, there is provided an information transmission method performed by a user equipment (UE). The method includes: sending a first sensing service request to a base station, where the first sensing service request is at least configured to request a network to provide a sensing service to the UE.

According to a third aspect of the embodiments of the present disclosure, there is provided a communication device, including a processor, a memory, and an executable program stored on the memory and executable by the processor, where the processor performs the steps of the method as described in the first aspect or the second aspect when running the executable program.

According to a fourth aspect of the embodiments of the present disclosure, there is provided a storage medium storing an executable program, where the executable program, when executed by a processor, implements the steps of the method as described in the first aspect or the second aspect.

It should be understood that the general description above and the detailed description below are only exemplary and explanatory, and cannot limit the embodiments of the present disclosure.

### BRIEF DESCRIPTION OF THE DRAWINGS

The accompanying drawings, which are incorporated into and constitute a part of the specification, illustrate embodiments in accordance with the embodiments of the present disclosure and together with the specification, serve to explain the principles of the embodiments of the present disclosure.

FIG. 1 is a schematic structural diagram of a wireless communication system according to an exemplary embodiment.

FIG. 2 is a schematic diagram of a registration request procedure according to an exemplary embodiment.

FIG. 3 is a flowchart of an information transmission method according to an exemplary embodiment.

FIG. 4 is a flowchart of another information transmission method according to an exemplary embodiment.

FIG. 5 is a flowchart of yet another information transmission method according to an exemplary embodiment.

FIG. 6 is a flowchart of yet another information transmission method according to an exemplary embodiment.

FIG. 7 is a flowchart of yet another information transmission method according to an exemplary embodiment.

FIG. 8 is a flowchart of yet another information transmission method according to an exemplary embodiment.

FIG. 9 is a block diagram of an information transmission apparatus according to an exemplary embodiment.

FIG. 10 is a block diagram of another information transmission apparatus according to an exemplary embodiment.

FIG. 11 is a block diagram of an apparatus for transmitting information according to an exemplary embodiment.

### DETAILED DESCRIPTION OF THE EMBODIMENTS

The exemplary embodiments will be described in detail herein, and examples thereof are shown in the accompanying drawings. When the following descriptions refer to the accompanying drawings unless otherwise indicated, the same numbers in different drawings represent the same or similar elements. The implementations described in the following exemplary embodiments do not represent all the implementations consistent with the embodiments of the present disclosure. Rather, they are merely examples of the apparatus and method consistent with some aspects of the embodiments of the present disclosure as detailed in the appended claims.

Terms used in the embodiments of the present disclosure are for the purpose of describing specific embodiments only, and are not intended to limit the embodiments of the present disclosure. The singular forms “a,” “an” and “this” used in the embodiments of the present disclosure and the appended claims are also intended to include plural forms, unless the context clearly indicates other meanings. It should also be understood that the term “and/or” as used herein refers to and includes any and all possible combinations of one or more of the associated listed items.

It should be understood that although terms first, second, third, etc. may be used in the embodiments of the present disclosure to describe various information, such information should not be limited to these terms. These terms are only used to distinguish the same type of information from each other. For example, first information may also be referred to as second information, and similarly, the second information may also be referred to as the first information without departing from the scope of the present disclosure. Depending on the context, the word “if” as used herein can be interpreted as “at the time of,” “when,” or “in response to determining.”

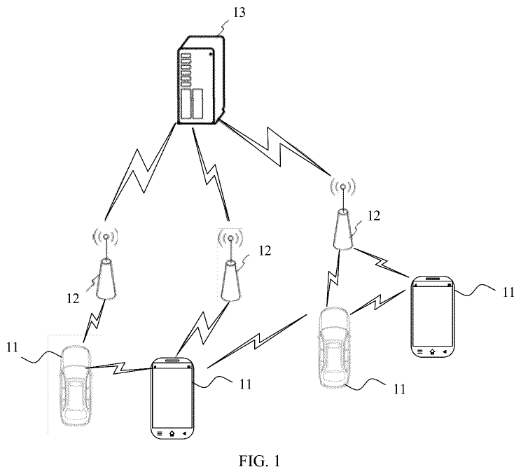

Referring to FIG. 1, FIG. 1 is a schematic structural diagram showing a wireless communication system provided in an embodiment of the present disclosure. As shown in FIG. 1, the wireless communication system is a communication system based on cellular mobile communication technology, and may include several terminals 11 and several base stations 12.

The terminal 11 may be a device that provides voice and/or data connectivity to a user. The terminal 11 may communicate with one or more core networks via a radio access network (RAN). The terminal 11 may be an Internet of Things terminal, such as a sensor device, a mobile phone (or a “cellular” phone) and a computer with an Internet of Things terminal. For example, the terminal 11 may be a fixed, portable, pocket-sized, handheld, built-in computer or vehicle-mounted apparatus, for example, a station (STA), a subscriber unit, a subscriber station, a mobile station, a mobile, a remote station, an access point, a remote terminal, an access terminal, a user terminal, a user agent, a user device, or user equipment (UE). Or, the terminal 11 may be a device of an unmanned aerial vehicle. Or, the terminal 11 may be a vehicle-mounted device, for example, a driving computer with a wireless communication function, or a wireless communication device externally connected with a driving computer. Or, the terminal 11 may be a roadside device, such as a street lamp, a signal lamp or other roadside devices with a wireless communication function.

The base station 12 may be a network side device in the wireless communication system. The wireless communication system may be a 4th generation mobile communication (4G) system, also referred to as a long term evolution (LTE) system. Or, the wireless communication system may be a 5G system, also referred to as a new radio (NR) system or a 5G NR system. Or, the wireless communication system may be a next generation system of the 5G system. The access network in the 5G system may be referred to as a new generation-radio access network (NG-RAN) or a machine type communication (MTC) system.

The base station 12 may be an evolved base station (eNB) used in the 4G system. Or, the base station 12 may be a centralized distributed architecture base station (gNB) used in the 5G system. When the base station 12 adopts the centralized distributed architecture, it usually includes a central unit (CU) and at least two distributed units (DUs). A protocol stack of a packet data convergence protocol (PDCP) layer, a radio link control (RLC) layer and a media access control (MAC) layer is provided in the central unit. A protocol stack of a physical (PHY) layer is provided in the distributed unit. The specific implementation of the base station 12 is not limited in the embodiments of the present disclosure.

A wireless connection may be established between the base station 12 and the terminal 11 through a wireless radio. In different embodiments, the wireless radio is a wireless radio based on the 4th generation mobile communication network technology (4G) standard. Or, the wireless radio is a wireless radio based on the 5th generation mobile communication network technology (5G) standard. For example, the wireless radio is a new radio. Or, the wireless radio may also be a wireless radio based on the next generation mobile communication network technology standard of the 5G.

In some embodiments, an end to end (E2E) connection may also be established between terminals 11, for example, a vehicle to vehicle (V2V) communication, a vehicle to infrastructure (V2I) communication and a vehicle to pedestrian (V2P) communication in a vehicle to everything (V2X) communication.

In some embodiments, the above wireless communication system may further include a network management device 13.

Several base stations 12 are connected to the network management device 13, respectively. The network management device 13 may be a core network device in the wireless communication system. For example, the network management device 13 may be a mobility management entity (MME) in an evolved packet core (EPC). Or, the network management device can also be other core network device, for example, a serving gateway (SGW), a public data network gateway (PGW), a policy and charging rules function (PCRF) or a home subscriber server (HSS), etc. The implementation form of the network management device 13 is not limited in the embodiments of the present disclosure.

Execution subjects involved in the embodiments of the present disclosure include but are not limited to: a mobile phone terminal in a cellular mobile communication system, a network side device, for example, an access network device such as a base station, and a core network.

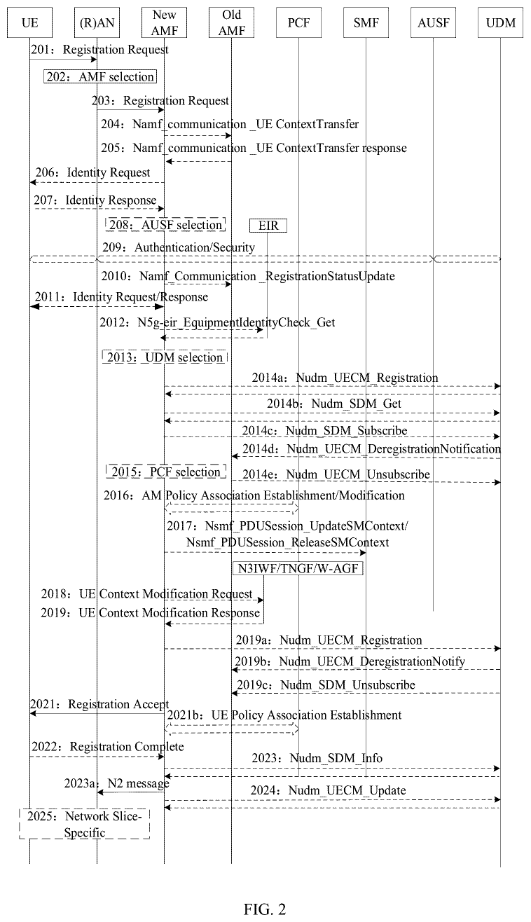

In related technologies, a registration request procedure is used to negotiate UE/Network capabilities between each other. The registration request procedure is shown in FIG. 2, which includes steps 201 to 2025.

In step 201, the UE sends a registration request message to an access network (RAN), where the registration request message includes capabilities of the UE, for example, a UE radio capability, a release request indication, etc.

In steps 202 to 203, the RAN selects an access and mobility management function (AMF) and forwards the registration request to the AMF.

In steps 204-219, authentication and authorization, UE identity check, etc. are performed. In step 2020, default.

In step 2021, the AMF sends a registration acceptance message to the UE, including which network capabilities the network can support corresponding to the UE capabilities. For example, paging restriction is supported.

In steps 2022-2025, acknowledgement as required by the network, network slice-specific authentication and authorization are performed, etc.

In related technologies, sensing capabilities are not supported by a 3GPP system, so there is no way to negotiate sensing capabilities between a UE and a network. Secondly, in the deployment of a sensing service, the sensing service can be deployed per gNB level and sensing capabilities can be negotiated between a UE and a core network. However, when the UE moves to an area/a base station coverage range that does not support the sensing service, the UE fails to initiate the sensing service.

How a UE initiates a sensing service, negotiates sensing capabilities with a network, and provides the sensing service is an urgent problem to be solved.

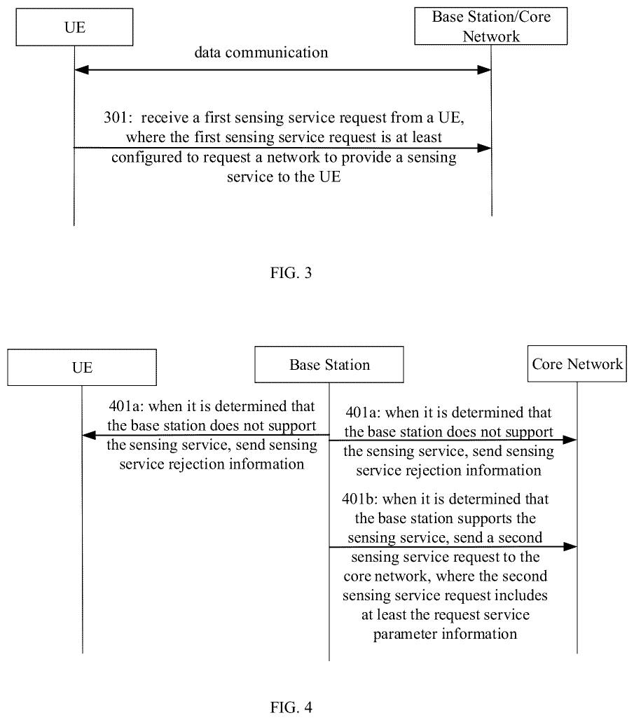

As shown in FIG. 3, this exemplary embodiment provides an information transmission method that can be performed by a base station of a cellular mobile communication system. The method includes step 301.

In step 301, a first sensing service request from a UE is received, where the first sensing service request is at least configured to request a network to provide a sensing service to the UE.

The UE can be a terminal such as a mobile phone in the cellular mobile communication system. The UE can be used as a communication device that receives sensing information. The UE can also transmit sensing information.

The network may include but is not limited to an access network, and/or a core network.

Sensing signals can be signals used for both data communication and environment sensing in the cellular mobile communication system. The sensing signals can be interfered by the surrounding environment during transmission, such as reflection, which will produce different changes. The UE senses the surrounding environment based on received sensing signals. The sensing signals can be radio frequency signals, including millimeter wave signals, terahertz signals, etc. The UE can also be used to transmit sensing signals for other communication devices to receive and sense the surrounding environment.

The UE can send the first sensing service request during accessing the base station and/or after establishing a connection with the base station.

The first sensing service request may include indication information for indicating a type of the requested sensing service, parameters of sensing service requirements, a sensing capability of the UE and/or an identifier indicating the UE, etc. The first sensing service request can be used to negotiate sensing capabilities with the network. The network can determine whether to accept providing the sensing service to the UE based on the first sensing service request, etc.

The network can determine whether to provide the sensing service to the UE based on the first sensing service request, and configure resources for the provided sensing service, etc.

For example, whether to provide the sensing service to the UE can be determined by the core network, and when it is determined to provide the sensing service to the UE, resources for the sensing service can be configured.

In an embodiment, the UE can send the first sensing service request to the base station when it is determined that the UE supports the sensing service and the accessed network also supports the sensing service.

The sensing service is deployed at a granularity of base stations, not all base stations support the sensing service, or a base station may not be able to support all types of sensing services. And whether the UE can obtain the sensing service also depends on service authorities of the UE and the resource status of the network. Therefore, the UE needs to send the first sensing service request to the network to request the sensing service, and the network determines whether the UE can obtain the sensing service. The inconsistency between the UE and the network in determining whether the UE can perform the sensing service is reduced, and the reliability of the UE for the sensing service is improved.

In this way, the UE requests the sensing service from the network through the first sensing service request. The network determines whether the UE can perform the sensing service, and configures the resources of the sensing service. The deployment of the sensing service at the granularity of base stations can be satisfied, and the request is made before performing the sensing service, reducing the inconsistency between the UE and the network in determining whether the UE can perform the sensing service, and improving the reliability of the UE for the sensing service.

In an embodiment, the first sensing service request includes at least one of the following:
a sensing service indication configured to indicate the sensing service, where sensing services indicated by different sensing service indications are different; or service parameter information of the sensing service.

The sensing service indication can be used to indicate to the base station the sensing service requested by the UE from the network.

The UE may not classify sensing services. A bit can be used to indicate that the UE requests a sensing service.

Sensing services can also be classified. For example, the sensing services can be classified based on business types of sensing services, types of sensing objects, and transmitting ends that transmit sensing signals. The sensing service indication can indicate a type of the sensing service. The sensing services indicated by different sensing service indications are different.

After receiving the first sensing service request, the base station can determine the sensing service requested by the UE and determine whether the sensing service is supported.

The service parameter information may include parameters of sensing service requirements of the sensing service requested by the UE, and the sensing capability of the UE. The service parameter information can be used for the core network to determine whether to accept the sensing service request of the UE and/or configure the resources of the sensing service based on the service parameter information.

The service parameter information can be non-access stratum (NAS) information. For example, the service parameter information can be a NAS sensing request container. The service parameter information can be transmitted transparently to the core network by the base station.

In an embodiment, the service parameter information includes at least one of the following: sensing capability information; sensing type information; sensing quality of service (QOS); or sensing object information.

The sensing capability information can be used to indicate the sensing capability of the UE, for example, a capability of the UE to receive sensing signals and/or a capability of the UE to transmit sensing signals.

The sensing type information can be used to indicate the type of sensing service requested by the UE. Types of sensing services can be classified based on business types of sensing services, types of sensing objects, transmitting ends that transmit sensing signals, and/or roles of the UE in sensing services, etc.

The sensing QOS can include QoS of communication data in the sensing service, and can also include QoS of sensing accuracy of a sensing object in the sensing service.

Sensing objects can be classified based on motion states, for example, dynamic objects and static objects. Sensing objects can be classified based on actual objects, for example, cars, buildings, etc.

The core network can determine whether to accept the sensing service request of the UE based on the service parameter information, and/or the core network can determine resources required for the sensing service based on the service parameter information, and allocate and configure the resources.

As shown in FIG. 4, this exemplary embodiment provides an information transmission method that can be performed by a base station of a cellular mobile communication system. The method further includes one of steps 401a and 401b.

In step 401a, sensing service rejection information is sent when it is determined that the base station does not support the sensing service.

In step 401b, when it is determined that the base station supports the sensing service, a second sensing service request is sent to the core network, where the second sensing service request includes at least the service parameter information.

Step 401a and/or step 401b can be implemented separately or in combination with step 301.

The base station can determine whether the base station supports the sensing service based on the sensing service indication.

The base station can also determine that the first sensing service request is for requesting the sensing service based on the service parameter information of the sensing service in the first sensing service request. The base station can determine whether to support the sensing service based on its own capability to support the sensing service.

The base station can also determine whether to support the UE to perform the sensing service based on the authorization of the UE. For example, the base station can determine whether the UE is allowed to perform the sensing service based on a UE identifier, such as UE ID, in the first sensing service request.

In an example, the base station may determine that the first sensing service request is used to request the sensing service based on the service parameter information of the sensing service indicated by the sensing service indication and/or in the first sensing service request. The base station may determine whether to support the sensing service based on its own sensing service capability.

If the base station does not support the sensing service indicated by the sensing service indication, the base station can send the sensing service rejection information. The base station can send the sensing service rejection information to the UE and/or the core network. The sensing service rejection information can be used to indicate that the base station does not support the sensing service.

In an embodiment, sending the sensing service rejection information includes at least one of the following:
sending first sensing service rejection information to the UE, where the first sensing service rejection information is configured to indicate that the network does not support the sensing service; or
sending second sensing service rejection information to the core network, where the second sensing service rejection information is configured to indicate that the network does not support the sensing service.

In an example, the base station may send the first sensing service rejection information to the UE with an access stratum (AS) message. That is, the base station can directly indicate to the UE that the sensing service is rejected. The base station can also send the first sensing service rejection information to the UE with a NAS message.

When the base station does not support the sensing service requested by the first sensing service request, the base station can also send the second sensing service rejection information to the core network, indicating that the base station does not support the sensing service. For example, the second sensing service rejection information can be carried by a NAS message.

After receiving the second sensing service rejection information, the core network can send the third sensing service rejection information to the UE with a NAS message, indicating that the network does not support the UE to perform the sensing service. The core network can also send the third sensing service rejection information to the UE through the base station using an AS message.

Here, the second sensing service rejection information sent by the base station to the core network can be received by an access and mobility management function (AMF) in the core network. And the AMF sends the third sensing service rejection information to the UE. The second sensing service rejection information can also be received and processed by other network elements in the core network, such as a sensing function (SF), and the third sensing service rejection information is sent to the UE through the AMF.

In an embodiment, the sensing service rejection information includes indication information indicating a rejection reason.

The reason why the base station or the core network refuses the UE to perform the sensing service may include: the base station does not support the sensing service, and/or the UE is not authorized to perform the sensing service. The sensing service rejection information sent to the UE by the base station or the core network, i.e., the first sensing service rejection information or the third sensing service rejection information, can carry the sensing service rejection information.

The sensing service rejection information sent by the base station to the core network, i.e., the second sensing service rejection information, can carry the service rejection information.

If the base station supports the sensing service indicated by the sensing service indication, the base station can send the second sensing service request to the core network.

The second sensing service request can carry the service parameter information for the core network to allocate and configure sensing service resources.

The second sensing service request can carry the sensing service capability of the base station for the core network to configure resources based on the capability of the base station.

The base station can send the service parameter information to the AMF in the core network, and the AMF will allocate and configure sensing service resources. The allocation and configuration of the sensing service resources can also be carried out by other network elements in the core network, such as the SF.

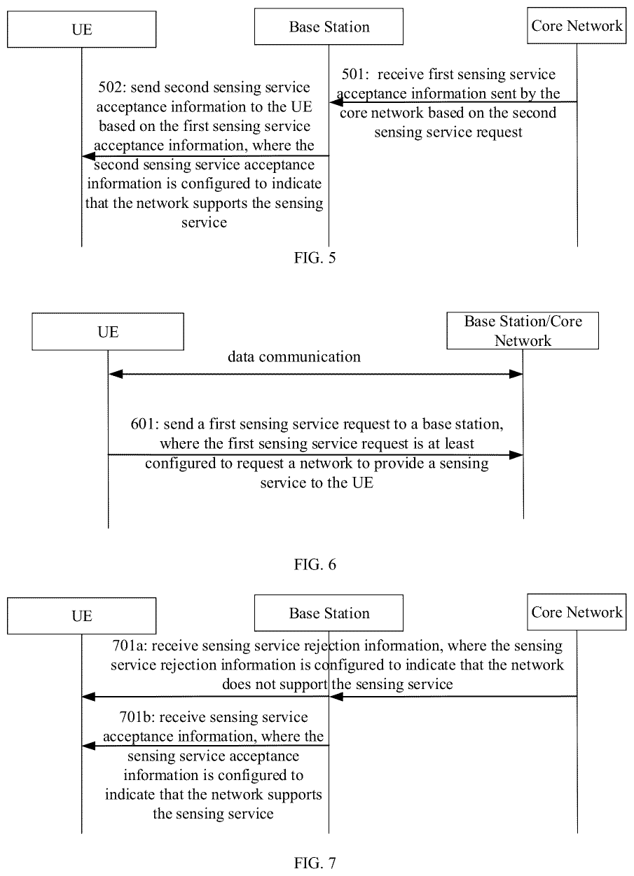

As shown in FIG. 5, this exemplary embodiment provides an information transmission method that can be performed by a base station of a cellular mobile communication system. The method further includes step 501.

In step 501, first sensing service acceptance information sent by the core network based on the second sensing service request is received.

As shown in FIG. 5, this exemplary embodiment provides an information transmission method that can be performed by a base station of a cellular mobile communication system. The method further includes step 502.

In step 502: second sensing service acceptance information is sent to the UE based on the first sensing service acceptance information, where the second sensing service acceptance information is configured to indicate that the network supports the sensing service.

Steps 501 and 502 can be implemented separately or in combination with steps 301, 401a, and/or 401b.

After receiving the second sensing service request and completing the resource allocation and configuration, the core network can send the first sensing service acceptance information to the base station, indicating that the core network allows the UE to perform the sensing service.

Here, the first sensing service acceptance information can be sent by the AMF in the core network, or can be sent by other network elements such as the SF in the core network through the AMF.

After receiving the first sensing service acceptance information, the base station can send the second sensing service acceptance information to the UE, indicating that the network allows the UE to perform the sensing service.

In an embodiment, the first sensing service acceptance information is at least configured to indicate resource configuration parameters of the UE for the sensing service and/or resource configuration parameters of the base station for the sensing service, where the resource configuration parameters of the UE for the sensing service and the resource configuration parameters of the base station for the sensing service are determined by the core network based on at least the service parameter information.

The second sensing service acceptance information is at least configured to indicate the resource configuration parameters of the UE for the sensing service.

Here, the resource configuration parameters of the base station and the UE can be determined by the AMF or by other network elements such as the SF in the core network.

The second sensing service acceptance information may also include resource configuration parameters configured by the base station for the UE to perform the sensing service.

As shown in FIG. 6, this exemplary embodiment provides an information transmission method that can be performed by a UE of a cellular mobile communication system. The method includes step 601.

In step 601: a first sensing service request is sent to a base station, where the first sensing service request is at least configured to request a network to provide a sensing service to the UE.

The UE can be a terminal such as a mobile phone in the cellular mobile communication system. The UE can be used as a communication device that receives sensing information. The UE can also transmit sensing information.

The network may include but is not limited to an access network, and/or a core network.

Sensing signals can be signals used for both data communication and environment sensing in the cellular mobile communication system. The sensing signals can be interfered by the surrounding environment during transmission, such as reflection, which will produce different changes. The UE senses the surrounding environment based on received sensing signals. The sensing signals can be radio frequency signals, including millimeter wave signals, terahertz signals, etc. The UE can also be used to transmit sensing signals so that other communication devices can receive and sense the surrounding environment.

The UE can send the first sensing service request during accessing the base station and/or after establishing a connection with the base station.

The first sensing service request may include indication information for indicating a type of the requested sensing service, parameters of sensing service requirements, a sensing capability of the UE and/or an identifier indicating the UE, etc. The first sensing service request can be used to negotiate sensing capabilities with the network. The network can determine whether to accept providing the sensing service to the UE based on the first sensing service request, etc.

The network can determine whether to provide the sensing service to the UE based on the first sensing service request, and configure resources for the provided sensing service, etc.

For example, whether to provide the sensing service to the UE can be determined by the core network, and when it is determined to provide the sensing service to the UE, resources for the sensing service can be configured.

In an embodiment, the UE can send the first sensing service request to the base station when it is determined that the UE supports the sensing service and the accessed network also supports the sensing service.

The sensing service is deployed at a granularity of base stations, not all base stations support the sensing service, or a base station may not be able to support all types of sensing services. And whether the UE can obtain the sensing service also depends on service authorities of the UE and the resource status of the network. Therefore, the UE needs to send the first sensing service request to the network to request the sensing service, and the network determines whether the UE can obtain the sensing service. The inconsistency between the UE and the network in determining whether the UE can perform the sensing service is reduced, and the reliability of the UE for the sensing service is improved.

In this way, the UE requests the sensing service from the network through the first sensing service request. Whether the UE can perform the sensing service is determined by the network, and resources of the sensing service are configured by the network. The deployment of the sensing service at the granularity of base stations can be satisfied, and the request is made before performing the sensing service, reducing the inconsistency between the UE and the network in determining whether the UE can perform the sensing service, and improving the reliability of the UE for the sensing service.

In an embodiment, the first sensing service request includes at least one of the following:
a sensing service indication configured to indicate the sensing service; or
service parameter information of the sensing service.

The sensing service indication can be used to indicate to the base station the sensing service requested by the UE from the network.

The UE may not classify sensing services. A bit can be used to indicate that the UE requests a sensing service.

Sensing services can also be classified. For example, the sensing services can be classified based on business types of sensing services, types of sensing objects, and transmitting ends that transmit sensing signals. The sensing service indication can indicate a type of the sensing service. The sensing services indicated by different sensing service indications are different.

After receiving the first sensing service request, the base station can determine the sensing service requested by the UE and determine whether the sensing service is supported.

The service parameter information may include parameters of sensing service requirements of the sensing service requested by the UE, and the sensing capability of the UE. The service parameter information can be used for the core network to determine whether to accept the sensing service request of the UE and/or configure the resources of the sensing service based on the service parameter information.

The service parameter information can be non-access stratum (NAS) information. For example, the service parameter information can be a NAS sensing request container. The service parameter information can be transmitted transparently to the core network by the base station.

In an embodiment, the service parameter information includes at least one of the following: sensing capability information; sensing type information; sensing quality of service (QOS); or sensing object information.

The sensing capability information can be used to indicate the sensing capability of the UE, for example, a capability of the UE to receive sensing signals and/or a capability of the UE to transmit sensing signals.

The sensing type information can be used to indicate the type of sensing service requested by the UE. Types of sensing services can be classified based on business types of sensing services, types of sensing objects, transmitting ends that transmit sensing signals, and/or roles of the UE in sensing services, etc.

The sensing QoS can include QoS of communication data in the sensing service, and can also include QoS of sensing accuracy of a sensing object in the sensing service.

Sensing objects can be classified based on motion states, for example, dynamic objects and static objects. Sensing objects can be classified based on actual objects, for example, cars, buildings, etc.

The core network can determine whether to accept the sensing service request of the UE based on the service parameter information, and/or the core network can determine resources required for the sensing service based on the service parameter information, and allocate and configure the resources.

As shown in FIG. 7, this exemplary embodiment provides an information transmission method that can be performed by a base station of a cellular mobile communication system. The method further includes one of steps 701a and 701b.

In step 701a: sensing service rejection information is received, where the sensing service rejection information is configured to indicate that the network does not support the sensing service.

In step 701b: sensing service acceptance information is received, where the sensing service acceptance information is configured to indicate that the network supports the sensing service.

Step 701a and/or step 701b can be implemented separately or in combination with step 601.

The base station can determine whether the base station supports the sensing service based on the sensing service indication.

The base station can also determine that the first sensing service request is for requesting the sensing service based on the service parameter information of the sensing service in the first sensing service request. The base station can determine whether to support the sensing service based on its own capability to support the sensing service.

The base station can also determine whether to support the UE to perform the sensing service based on the authorization of the UE. For example, the base station can determine whether the UE is allowed to perform the sensing service based on a UE identifier, such as UE ID, in the first sensing service request.

In an example, the base station may determine that the first sensing service request is used to request the sensing service based on the service parameter information of the sensing service indicated by the sensing service indication and/or in the first sensing service request. The base station may determine whether to support the sensing service based on its own sensing service capability.

If the base station does not support the sensing service indicated by the sensing service indication, the base station can send the sensing service rejection information. The base station can send the sensing service rejection information to the UE and/or the core network.

The sensing service rejection information can also be sent by the core network. The core network can determine whether to allow the UE to perform the sensing service based on the capability of the base station and/or whether the UE is authorized to perform the sensing service. If not, the core network will send the sensing service rejection information to the UE.

In an embodiment, receiving the sensing service rejection information includes at least one of the following:
receiving first sensing service rejection information sent by the base station; or
receiving third sensing service rejection information sent by the core network, where the third sensing service rejection information is triggered by the core network based on second sensing service rejection information sent by the base station.

The base station may send the first sensing service rejection information to the UE with an access stratum (AS) message. That is, the base station can directly indicate to the UE that the sensing service is rejected. The base station can also send the first sensing service rejection information to the UE with a NAS message.

When the base station does not support the sensing service requested by the first sensing service request, the base station can also send the second sensing service rejection information to the core network, indicating that the base station does not support the sensing service. For example, the second sensing service rejection information can be carried by a NAS message.

After receiving the second sensing service rejection information, the core network can send the third sensing service rejection information to the UE with a NAS message, indicating that the network does not support the UE to perform the sensing service. The core network can also send the third sensing service rejection information to the UE through the base station using an AS message.

Here, the second sensing service rejection information sent by the base station to the core network can be received by an access and mobility management function (AMF) in the core network. And the AMF sends the third sensing service rejection information to the UE. The second sensing service rejection information can also be received and processed by other network elements in the core network, such as a sensing function (SF), and the third sensing service rejection information is sent to the UE through the AMF.

In an embodiment, the sensing service rejection information includes indication information indicating a rejection reason.

The reason why the base station or the core network refuses the UE to perform the sensing service may include: the base station does not support the sensing service, and/or the UE is not authorized to perform the sensing service. The sensing service rejection information sent to the UE by the base station or the core network, i.e., the first sensing service rejection information or the third sensing service rejection information, can carry the sensing service rejection information.

The sensing service rejection information sent by the base station to the core network, i.e., the second sensing service rejection information, can carry the service rejection information.

If the base station supports the sensing service indicated by the sensing service indication, the base station can send a second sensing service request to the core network.

The second sensing service request can carry the service parameter information for the core network to allocate and configure sensing service resources.

The second sensing service request can carry the sensing service capability of the base station for the core network to configure resources based on the capability of the base station.

The base station can send the service parameter information to the AMF in the core network, and the AMF will allocate and configure sensing service resources. The allocation and configuration of the sensing service resources can also be carried out by other network elements in the core network, such as the SF.

In an embodiment, the base station receives first sensing service acceptance information sent by the core network based on the second sensing service request.

In an embodiment, the base station sends second sensing service acceptance information to the UE based on the first sensing service acceptance information. The second sensing service acceptance information is used to indicate that the network supports the sensing service.

After receiving the second sensing service request and completing the resource allocation and configuration, the core network can send the first sensing service acceptance information to the base station, indicating that the core network allows the UE to perform the sensing service.

Here, the first sensing service acceptance information can be sent by the AMF in the core network, or can be sent by other network elements such as the SF in the core network through the AMF.

After receiving the first sensing service acceptance information, the base station can send the second sensing service acceptance information to the UE, indicating that the network allows the UE to perform the sensing service.

In an embodiment, the sensing service acceptance information (i.e., the above second sensing service acceptance information) is at least used to indicate resource configuration parameters for the UE to perform the sensing service.

Here, the resource configuration parameters of the base station and the UE can be determined by the AMF or by other network elements such as the SF in the core network.

The second sensing service acceptance information may also include resource configuration parameters configured by the base station for the UE to perform the sensing service.

A specific example is provided below in combination with any of the above embodiments.

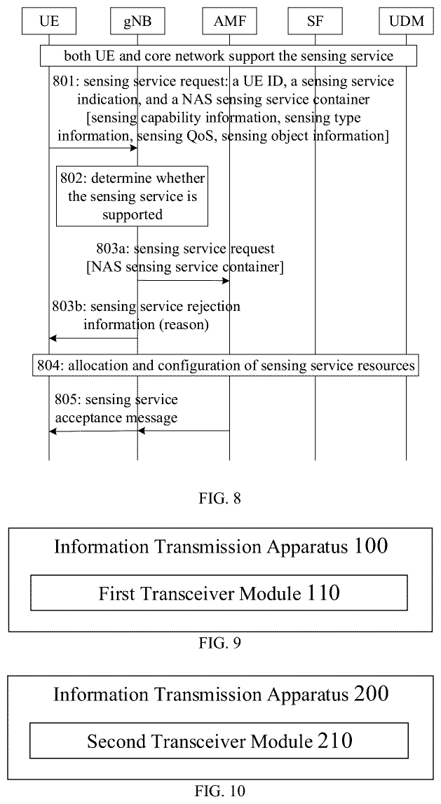

As shown in FIG. 8, for the case where the sensing service is deployed at the granularity of access networks (such as base stations), specific steps of exchanging sensing capabilities between a UE and a core network include steps 801 to 805.

In step 801, the UE sends a sensing service request to a base station (such as gNB), which includes: a UE ID, a sensing service indication, and service parameter information of the sensing service (for example, a NAS sensing request container, which may include sensing capability information, sensing type information, sensing quality of service (QOS), sensing object information)

In step 802, the base station determines whether the sensing service is supported. When receiving the sensing service request, the base station determines that the UE requests the sensing service based on the sensing service indication or by detecting whether there is a NAS sensing request container.

In step 803a, when the base station supports the sensing service, the base station forwards the sensing service request to an AMF. Optionally, the sensing service request can carry the sensing service capability of the base station.

In step 803b, when the base station does not support the sensing service, the base station rejects the sensing service request and indicates a rejection reason.

In an embodiment, when the base station does not support the sensing service, the base station will send a NAS message (the service request) to the AMF indicating that the sensing service is not supported. The AMF sends a NAS message to the UE to reject the service request.

In step 804, when receiving a sensing service request from the base station, the AMF triggers the allocation and configuration of sensing service resources from the network to the gNB and the UE.

In step 805, the AMF sends sensing service acceptance messages to the base station and the UE, with sensing service related parameters of the gNB/the UE.

An embodiment of the present disclosure also provides an information transmission apparatus, as shown in FIG. 9, applied to a base station in a cellular mobile wireless communication. The apparatus 100 includes a first transceiver module 110.

The first transceiver module 110 is configured to receive a first sensing service request from a user equipment (UE), where the first sensing service request is at least configured to request a network to provide a sensing service to the UE.

In an embodiment, the first sensing service request includes at least one of the following: a sensing service indication configured to indicate the sensing service, where sensing services indicated by different sensing service indications are different; or service parameter information of the sensing service.

In an embodiment, the service parameter information includes at least one of: sensing capability information; sensing type information; sensing quality of service (QOS); or sensing object information.

In an embodiment, the first transceiver module 110 is further configured to one of: when it is determined that the base station does not support the sensing service, send sensing service rejection information; or when it is determined that the base station supports the sensing service, send a second sensing service request to a core network, where the second sensing service request includes at least the service parameter information.

In an embodiment, the first transceiver module 110 is specifically configured to at least one of the following: send first sensing service rejection information to the UE, where the first sensing service rejection information is configured to indicate that the network does not support the sensing service; or send second sensing service rejection information to the core network, where the second sensing service rejection information is configured to indicate that the network does not support the sensing service.

In an embodiment, the sensing service rejection information includes indication information indicating a rejection reason.

In an embodiment, the first transceiver module 110 is further configured to: receive first sensing service acceptance information sent by the core network based on the second sensing service request.

In an embodiment, the first transceiver module 110 is further configured to: send second sensing service acceptance information to the UE based on the first sensing service acceptance information, where the second sensing service acceptance information is configured to indicate that the network supports the sensing service.

In an embodiment, the first sensing service acceptance information is at least configured to indicate resource configuration parameters of the UE for the sensing service and/or resource configuration parameters of the base station for the sensing service, where the resource configuration parameters of the UE for the sensing service and the resource configuration parameters of the base station for the sensing service are determined by the core network based on at least the service parameter information; the second sensing service acceptance information is at least configured to indicate the resource configuration parameters of the UE for the sensing service.

An embodiment of the present disclosure also provides an information transmission apparatus, as shown in FIG. 10, applied to a UE in a cellular mobile wireless communication. The apparatus 200 includes a second transceiver module 210.

The second transceiver module 210 is configured to send a first sensing service request to a base station, where the first sensing service request is at least configured to request a network to provide a sensing service to a user equipment (UE).

In an embodiment, the first sensing service request includes at least one of the following: a sensing service indication configured to indicate the sensing service; or service parameter information of the sensing service.

In an embodiment, the service parameter information includes at least one of: sensing capability information; sensing type information; sensing quality of service (QOS); or sensing object information.

In an embodiment, the second transceiver module 210 is further configured to one of: receive sensing service rejection information, where the sensing service rejection information is configured to indicate that the network does not support the sensing service; or receive sensing service acceptance information, where the sensing service acceptance information is configured to indicate that the network supports the sensing service.

In an embodiment, the second transceiver module 210 is specifically configured to at least one of the following: receive first sensing service rejection information sent by the base station; or receive third sensing service rejection information sent by a core network, where the third sensing service rejection information is triggered by the core network based on second sensing service rejection information sent by the base station.

In an embodiment, the sensing service rejection information includes indication information indicating a rejection reason.

In an embodiment, the sensing service acceptance information is at least configured to indicate resource configuration parameters of the UE for the sensing service.

In an exemplary embodiment, the first transceiver module 110, the second transceiver module 210, and the like may be implemented by one or more central processing units (CPUs), graphics processing units (GPUs), baseband processors (BPs), application specific integrated circuits (ASICs), DSPs, programmable logic devices (PLDs), complex programmable logic devices (CPLDs), field-programmable gate arrays (FPGAs), general purpose processors, controllers, micro controller units (MCUs), microprocessors or other electronic components for performing the aforementioned methods.

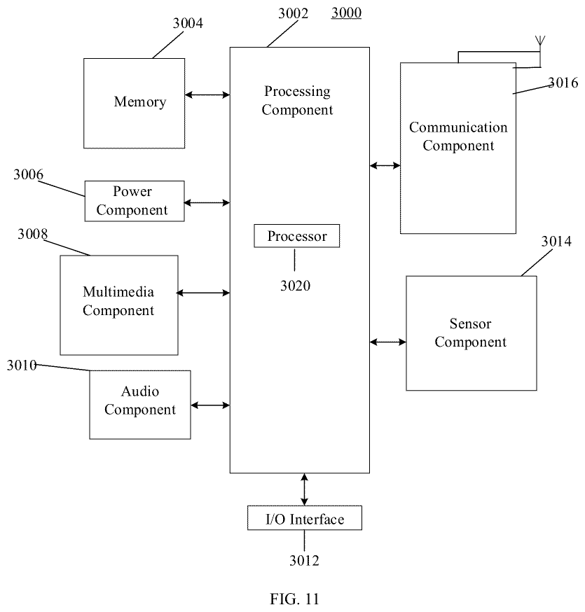

FIG. 11 is a block diagram of an apparatus 3000 for transmitting information according to an exemplary embodiment. For example, the apparatus 3000 may be a mobile phone, a computer, a digital broadcasting terminal, a messaging device, a game console, a tablet device, a medical device, a fitness device, a personal digital assistant, or the like.

Referring to FIG. 12, the apparatus 3000 can include one or more of the following components: a processing component 3002, a memory 3004, a power component 3006, a multimedia component 3008, an audio component 3010, an input/output (I/O) interface 3012, a sensor component 3014, and a communication component 3016.

The processing component 3002 generally controls the overall operations of the apparatus 3000, such as operations associated with display, telephone calls, data communications, camera operations, and recording operations. The processing component 3002 can include one or more processors 3020 to execute instructions to complete all or part of the steps of the above methods. In addition, the processing component 3002 can include one or more modules to facilitate interaction between the processing component 3002 and other components. For example, the processing component 3002 can include a multimedia module to facilitate interaction between the multimedia component 3008 and the processing component 3002.

The memory 3004 is configured to store various types of data to support operations at the apparatus 3000. Examples of such data include instructions for any application or method operating on the apparatus 3000, contact data, phone book data, messages, pictures, videos, and so on. The memory 3004 can be implemented by any type of volatile or non-volatile storage device or a combination thereof, such as static random access memory (SRAM), electrically erasable programmable read only memory (EEPROM), erasable programmable read only memory (EPROM), programmable read only memory (PROM), read only memory (ROM), magnetic memory, flash memory, magnetic disk or optical disk.

The power component 3006 provides power to various components of the apparatus 3000. The power component 3006 can include a power management system, one or more power sources, and other components associated with generating, managing, and distributing power for the apparatus 3000.

The multimedia component 3008 includes a screen that provides an output interface between the apparatus 3000 and a user. In some embodiments, the screen can include a liquid crystal display (LCD) and a touch panel (TP). If the screen includes a touch panel, the screen can be implemented as a touch screen to receive input signals from the user. The touch panel includes one or more touch sensors to sense touches, swipes, and gestures on the touch panel. The touch sensor can not only sense boundaries of a touch or swipe action, but also detect the duration and pressure related to the touch or swipe action. In some embodiments, the multimedia component 3008 includes a front camera and/or a rear camera. When the apparatus 3000 is in an operation mode, such as a shooting mode or a video mode, the front camera and/or the rear camera can receive external multimedia data. Each of the front and rear cameras can be a fixed optical lens system or have focal length and optical zooming capabilities.

The audio component 3010 is configured to output and/or input audio signals. For example, the audio component 3010 includes a microphone (MIC) that is configured to receive external audio signals when the apparatus 3000 is in an operation mode, such as a call mode, a recording mode, and a voice recognition mode. The received audio signals can be further stored in the memory 3004 or transmitted via the communication component 3016. In some embodiments, the audio component 3010 further includes a speaker for outputting audio signals.

The I/O interface 3012 provides an interface between the processing component 3002 and peripheral interface modules. The peripheral interface modules can be keyboards, a click wheels, a buttons, or the like. These buttons can include, but are not limited to, home button, volume button, start button, and lock button.

The sensor component 3014 includes one or more sensors for providing the apparatus 3000 with status assessment in various aspects. For example, the sensor component 3014 can detect an open/closed state of the apparatus 3000, relative positioning of components, such as the display and keypad of the apparatus 3000. The sensor component 3014 can also detect a change in position of the apparatus 3000 or a component of the apparatus 3000, the presence or absence of user contact with the apparatus 3000, orientation or acceleration/deceleration of the apparatus 3000, and temperature change of the apparatus 3000. The sensor component 3014 can include a proximity sensor configured to detect the presence of nearby objects without any physical contact. The sensor component 3014 can also include a light sensor, such as a Complementary Metal-Oxide-Semiconductor (CMOS) or Charged Coupled Device (CCD) image sensor, for use in imaging applications. In some embodiments, the sensor component 3014 can further include an acceleration sensor, a gyro sensor, a magnetic sensor, a pressure sensor, or a temperature sensor.

The communication component 3016 is configured to facilitate wired or wireless communication between the apparatus 3000 and other devices. The apparatus 3000 can access a wireless network based on a communication standard, such as Wi-Fi, 2G, 3G, 4G or 5G, or a combination thereof. In an exemplary embodiment, the communication component 3016 receives broadcast signals or broadcast-related information from an external broadcast management system via a broadcast channel. In one exemplary embodiment, the communication component 3016 also includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an exemplary embodiment, the apparatus 3000 can be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors or other electronic components for performing the above methods.

In an exemplary embodiment, there is also provided a non-transitory computer readable storage medium including instructions, such as the memory 3004 including instructions executable by the processor 3020 of the apparatus 3000 to implement the above methods. For example, the non-transitory computer readable storage medium can be a ROM, a random access memory (RAM), a CD-ROM, a magnetic tape, a floppy disk, and an optical data storage device, etc.

Those skilled in the art will readily recognize other embodiments of the present disclosure upon consideration of the specification and practice of the present disclosure disclosed herein. The present disclosure is intended to cover any variations, uses, or adaptations of the present disclosure, which follow general principles of the embodiments of the present disclosure and include common knowledge or customary means in the art that are not disclosed in the present disclosure. The specification and embodiments are exemplary only, with the true scope and spirit of the present disclosure being indicated by the following claims.

It should be understood that the present disclosure is not limited to the precise structure that has been described above and shown in the drawings, and various modifications and changes may be made without departing from the scope thereof. The scope of the present disclosure is limited only by the appended claims.

1. A method for information transmission, performed by a base station, the method comprising:
receiving a first sensing service request from a user equipment (UE), wherein the first sensing service request is at least configured to request a network to provide a sensing service to the UE.

2. The method according to claim 1, wherein the first sensing service request comprises at least one of:
a sensing service indication configured to indicate the sensing service; or
service parameter information of the sensing service.

3. The method according to claim 2, wherein the service parameter information comprises at least one of:
sensing capability information;
sensing type information;
sensing quality of service (QOS); or
sensing object information.

4. The method according to claim 2, further comprising one of:
when it is determined that the base station does not support the sensing service, sending sensing service rejection information; or
when it is determined that the base station supports the sensing service, sending a second sensing service request to a core network, wherein the second sensing service request comprises at least the service parameter information.

5. The method according to claim 4, wherein sending the sensing service rejection information comprises at least one of:
sending first sensing service rejection information to the UE, wherein the first sensing service rejection information is configured to indicate that the network does not support the sensing service; or
sending second sensing service rejection information to the core network, wherein the second sensing service rejection information is configured to indicate that the network does not support the sensing service.

6. The method according to claim 4, wherein the sensing service rejection information comprises indication information indicating a rejection reason.

7. The method according to claim 4, further comprising:
receiving first sensing service acceptance information sent by the core network based on the second sensing service request.

8. The method according to claim 7, further comprising:
sending second sensing service acceptance information to the UE based on the first sensing service acceptance information, wherein the second sensing service acceptance information is configured to indicate that the network supports the sensing service.

9. The method according to claim 7, wherein,
the first sensing service acceptance information is at least configured to indicate resource configuration parameters of the UE for the sensing service and/or resource configuration parameters of the base station for the sensing service, wherein the resource configuration parameters of the UE for the sensing service and the resource configuration parameters of the base station for the sensing service are determined by the core network based on at least the service parameter information;
the second sensing service acceptance information is at least configured to indicate the resource configuration parameters of the UE for the sensing service.

10. A method for information transmission, performed by a user equipment (UE), the method comprising:
sending a first sensing service request to a base station, wherein the first sensing service request is at least configured to request a network to provide a sensing service to the UE.

11. The method according to claim 10, wherein the first sensing service request comprises at least one of:
a sensing service indication configured to indicate the sensing service, wherein sensing services indicated by different sensing service indications are different; or
service parameter information of the sensing service.

12. The method according to claim 11, wherein the service parameter information comprises at least one of:
sensing capability information;
sensing type information;
sensing quality of service (QOS); or
sensing object information.

13. The method according to claim 11, further comprising one of:
receiving sensing service rejection information, wherein the sensing service rejection information is configured to indicate that the network does not support the sensing service; or
receiving sensing service acceptance information, wherein the sensing service acceptance information is configured to indicate that the network supports the sensing service.

14. The method according to claim 13, wherein receiving the sensing service rejection information comprises at least one of:
receiving first sensing service rejection information sent by the base station; or
receiving third sensing service rejection information sent by a core network, wherein the third sensing service rejection information is triggered by the core network based on second sensing service rejection information sent by the base station.

15. The method according to claim 13, wherein the sensing service rejection information comprises indication information indicating a rejection reason.

16. The method according to claim 13, wherein the sensing service acceptance information is at least configured to indicate resource configuration parameters of the UE for the sensing service.

17.-18. (canceled)

19. A communication device, comprising:
a memory, and
an executable program stored on the memory; and
one or more processors that execute the executable program, wherein the executable program when collectively executed by the one or more processors, cause the communication device to:
receive a first sensing service request from a user equipment (UE), wherein the first sensing service request is at least configured to request a network to provide a sensing service to the UE.

20. A non-transitory storage medium storing an executable program, wherein the executable program, when executed by a processor of the base station, cause the base station to perform the method according to claim 1.

21. A communication device, comprising:
a memory,
an executable program stored on the memory; and
one or more processors that execute the executable program, wherein the executable program when collectively executed by the one or more processors cause the communication device to perform the method according to claim 10.

22. A non-transitory storage medium storing an executable program, wherein the executable program, when executed by a processor of the UE, cause the UE to perform the method according to claim 10.
